(19) United States
(12) Patent Application Publication
(10) Pub. No.: US 2007/0143338 A1
(43) Pub. Date: Jun. 21, 2007

(54) Method and system for automatically building intelligent reasoning models based on Bayesian networks using relational databases

(76) Inventors: Haiqin Wang, Sammamish, WA (US); Alice Chen, Redmond, WA (US); Guijun Wang, Issaquah, WA (US); Changzhou Wang, Bellevue, WA (US)

Correspondence Address: KLEIN, O'NEILL & SINGH, LLP, 43 CORPORATE PARK, SUITE 204, IRVINE, CA, 92606, US

(21) Appl. No.: 11/314,845

(22) Filed: Dec. 21, 2005

(51) Int. Cl. G06F 7/00

(52) U.S. Cl. 707/103 R

(57) ABSTRACT

Method and system of building a reasoning model using relational databases is provided. The method includes identifying data objects in relational databases; determining dependency relationships between the data objects; translating the data objects into nodes of a Bayesian network; and automatically translating the dependency relationships into a graphical structure of a Bayesian network. The system includes at least one server for storing data of a system having numerous interconnected parts; monitoring agents for monitoring the data of the numerous interconnected parts stored in the system; an events log for storing any event observed by the monitoring agents; and relational databases for storing data objects, the data objects correspond to the data of the numerous interconnected parts.

### BACKGROUND OF THE INVENTION

1. Field of the Invention

The present invention relates to computing systems, and more particularly, to building intelligent reasoning models based on Bayesian networks.

2. Background

As a powerful framework for knowledge representation and intelligent reasoning, Bayesian networks are used in diagnostic and prognostic applications. However, with the lack of efficient tools for building high-quality Bayesian network models, the modeling process becomes a bottleneck to broad deployment of this technology. To build these models, the traditional method is to extract domain knowledge from human experts.

Conventional method for building models rely on manual input from domain experts. Typically, domain experts are interviewed for knowledge engineering, which results in a significant amount of interaction with human beings. The availability of experts is often limited and human judgment about probability is systematically error-prone. Therefore, the conventional knowledge engineering approach to model building is largely a manual and labor-intensive process and hence undesirable.

Therefore, what is needed is a method and system for automatically generating Bayesian networks for intelligent reasoning such as diagnosis and prognosis with minimum manual input/human interaction.

### SUMMARY OF THE PRESENT INVENTION

In one aspect of the present invention, a method of building a reasoning model using relational databases is provided. The method includes identifying data objects in relational databases; determining dependency relationships between the data objects; translating the data objects into nodes of a Bayesian network; and automatically translating the dependency relationships into a graphical structure of a Bayesian network.

A system for building a reasoning model using relational databases is provided. The system includes at least one server for storing data of a system having numerous interconnected parts; monitoring agents for monitoring the data of the numerous interconnected parts stored in the system; an events log for storing any event observed by the monitoring agents; and relational databases for storing data objects, the data objects correspond to the data of the numerous interconnected parts.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A illustrates a top-level block diagram of a system using the method of automatically building intelligent reasoning models based on Bayesian network form, according to one aspect of the present invention;

FIG. 1B illustrates a block diagram of the internal architecture of the host system in FIG. 1A;

FIG. 1C is a flow chart illustrating the steps of automatically building intelligent reasoning models based on Bayesian network form;

FIG. 2 illustrates a snapshot of a fragment of the Bayesian network generated from relational databases;

FIG. 3 illustrates an example of a table located in a relational database in one embodiment of the present invention;

FIG. 4 illustrates another example of a table located in a relational database in one embodiment of the present invention; and

FIG. 5 illustrates a typical example of a log of monitored data in one embodiment of the present invention.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to the present invention, a method for building intelligent reasoning models, based on Bayesian networks, from relational databases is provided. Reasoning models are particularly useful for the aircraft industry; however the method of the present invention can construct reasoning models that can be used to troubleshoot any system having a number of interconnected components, such as the complex systems created by the automotive, locomotive, marine, electronics, power generation, medical and computer industries. As more and more systems use relational databases as data repository and event log, this method of the present invention for automatically modeling Bayesian networks can be widely employed in other application domains.

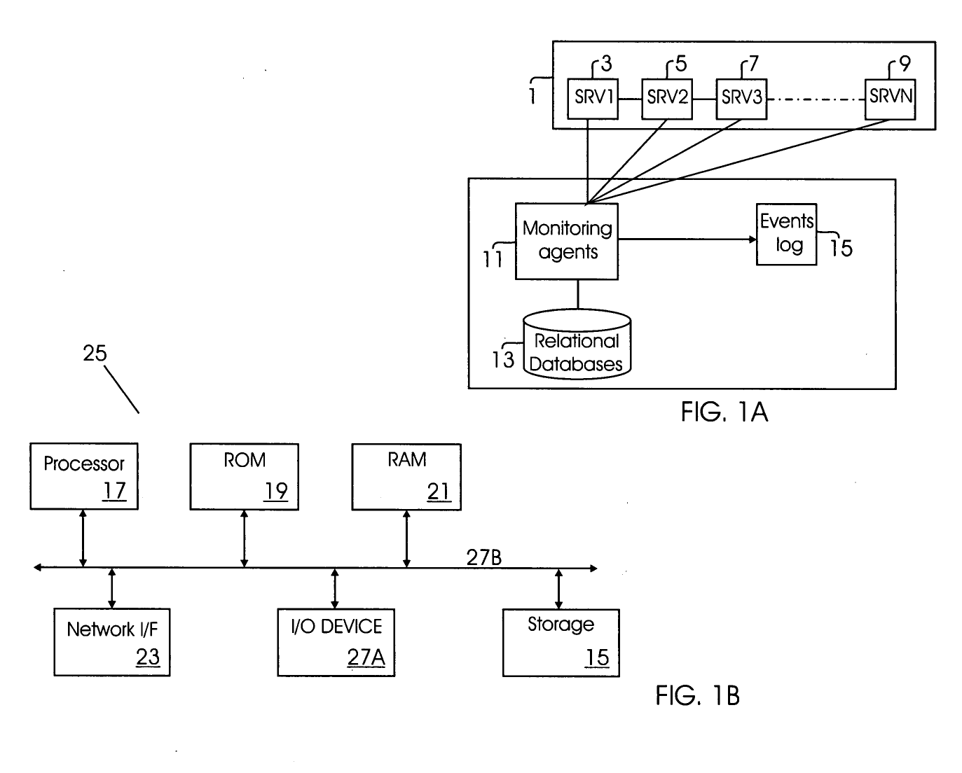

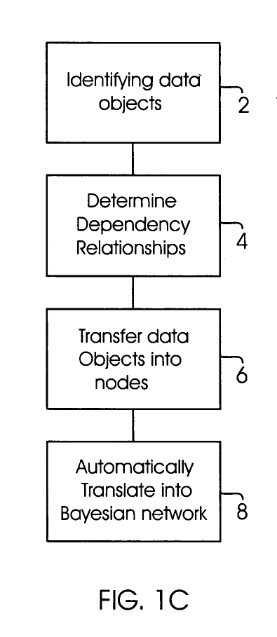

Turning to FIG. 1A, a block diagram of a system 1 using the method of automatically building intelligent reasoning models based on Bayesian network form is illustrated. System 1 is comprised of multiple servers (shown as 3, 5, 7 and 9). These servers are computing systems that are coupled to a network, for example, the Internet. Monitoring agents 11 constantly monitor data on servers 3, 5, 7 and 9 for any events and then store the events in an events log 15. Monitoring agents 11 in this context can be computer code or hardware designed to perform specific tasks. Events include any type of occurrence in system 1 such as a failure of a system component or the delivery of information or documents. Relational databases 13, which are comprised of multiple tables, are connected to monitoring agents 11. Data objects are extracted from relational databases 13 and provided to monitoring agents 11 for monitoring servers 3, 5, 7 and 9.

FIG. 1B illustrates a block diagram of a typical computing system (may also be referred to as a host computer or system) 25 that includes a central processing unit (“CPU”) (or microprocessor) 17 connected to a system bus 27B. Computing system 25 may be used for servers 3, 5, 7 and 9 (FIG. 1A). Random access main memory (“RAM”) 21 is coupled to system bus 27B and provides CPU 17 with access to memory storage. When executing program instructions, CPU 101 stores those process steps in RAM 21 and executes the stored process steps out of RAM 21.

Host system 25 connects to a computer network (not shown) via network interface 23 (and through a network connection (not shown)). One such network is the Internet that allows host system 25 to download applications, code, documents and others electronic information.

Read only memory (“ROM”) 19 is provided to store invariant instruction sequences such as start-up instruction sequences or basic Input/output operating system (BIOS) sequences.

Input/Output (“I/O”) device interface 27A allows host 25 to connect to various input/out devices, for example, a keyboard, a pointing device (“mouse”), a monitor, printer, a modem and the like. I/O device interface 27A is shown a single block for simplicity and may include plural interfaces to interface with different types of I/O devices.

It is noteworthy that the present invention is not limited to the architecture of the computing system shown in FIG. 1B. Based on the type of applications/business environment, computing system 25 may have more or fewer components. For example, computing system 25 can be a set-top box, a lap-top computer, a notebook computer, a desktop system or other types of systems.

Turning to FIG. 1C, a flow chart illustrating the steps of automatically building intelligent reasoning models based on Bayesian network form is shown. First, data objects in the relational databases that are relative to a defined reasoning task, such as determining how a particular server will perform in the future, are identified 2. Examples of data objects include airplane components subject to possible failures, the findings or observations caused by such failures, and the aggregated health status of an airplane system. Next, dependency relationships between the data objects are determined 4 and then the data objects are translated into nodes of a Bayesian network 6. Finally, the dependency relationships between the data objects are automatically translated into a graphical structure of a Bayesian network 8.

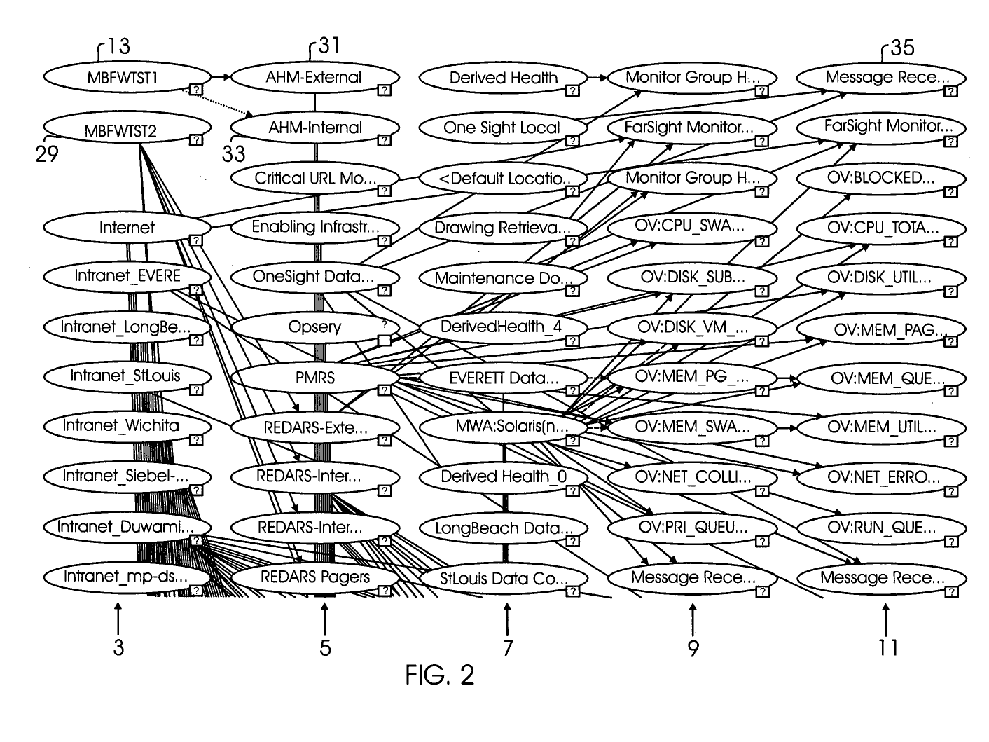

A snapshot of a fragment of a Bayesian network generated from the method of the present invention is illustrated in FIG. 2. The network is comprised of five columns of nodes. Nodes in the first column 3 represent a host computer or Internet connections. Nodes in the second column 5 represent web applications, such as software for performing a particular task, while the third column 7 represents monitoring agents which constantly monitor data in the system and generate observation nodes in the fourth and fifth columns 9, 11.

The web applications can be used to perform numerous functions such as document retrieval. Monitoring agents located in the third column 7 simulate web requests to the server by sending a request to a web application in the second column 5. The web application then responds to the monitoring agent by providing the requested document in a reasonable time frame. When the requested document is sent, an alert will be issued. The alerts are classified into three categories: critical, warning or normal. For example, if an observation node, in the fourth or fifth columns 9, 11 indicates a long delay between the request and the delivery of the document, a warning message is displayed. If the document was not received within the preset time-out threshold, a critical message is displayed indicating immediate attention is required. Not all nodes indicate the same problem as the observation nodes are connected to different nodes, thus each of the nodes are responsible for only a certain group of web applications or monitoring agents.

If an observation node, as shown in FIG. 2, indicates “message received” 35, it is possible that the message received is in a critical state, i.e. the message took too long to be received or the message wasn't received at all because the time threshold previously set by the system has been exceeded. As the links are shown on the network, the monitoring agent related to a particular message is identified. How the web applications (server) are related is also identified as well as how the host and Internet are related to the web applications.

It is possible to have multiple probable causes for an abnormal event. Depending on which node and which group of nodes have what kind of alert (such as critical or merely a warning as described above), the posterior probabilities of the probable causes can be computed based on the Bayesian network model to help fault isolation. For example, if a piece of hardware is slow, posterior probability might indicate how likely it will be for a particular web application to be slow or how likely a particular message is to occur. If a critical message is observed, it is possible to determine if there are problems with the related monitoring group.

Backwards reasoning based on the Bayesian network model is used to diagnose which monitoring group has a problem. In the reasoning, partial observed evidence is added on to the prior knowledge about the system behavior. With the combination of the evidence and prior knowledge, the posterior probability can be computed based on the probability theory. According to the updated belief of the posterior probabilities, a determination can be made as to what is the most likely cause of the problem or failure. There exists software to provide standard algorithms to perform the reasoning task.

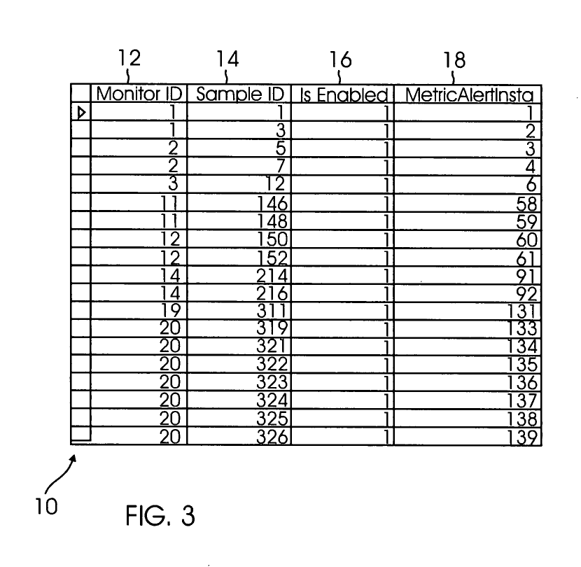

The relational databases, as discussed above, are comprised of multiple tables of data. FIG. 3 illustrates an example of a table 10 located in a relational database. Contained in table 10 is a monitoring ID column 12 containing a monitoring ID for each of the monitoring agents, a sample ID column 14 which identifies a particular type of event, an enabled column 16 which indicates if the monitoring agent is enabled and a metric alert instance column 18 containing an identifier that lists all the possible failures associated with a particular monitoring agent.

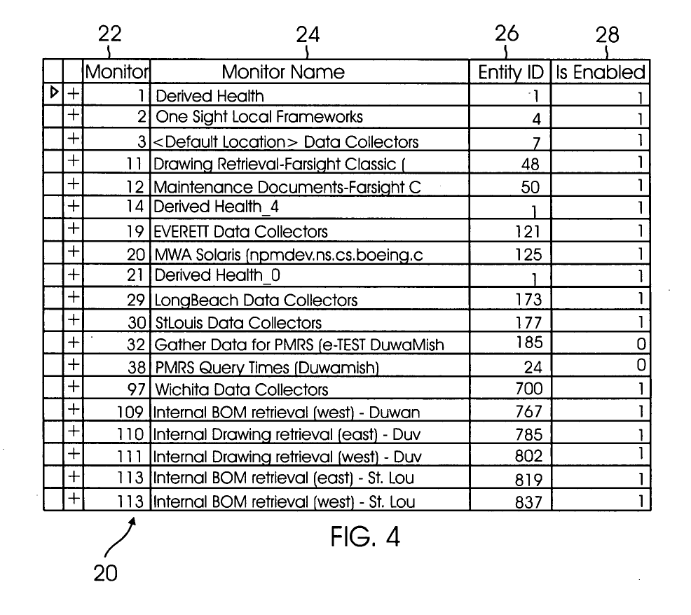

FIG. 4 illustrates another example of a table 20 located in a relational database. Table 20 contains a monitoring ID column 22 containing a monitoring ID for each monitoring agent, a monitor name column 24 containing the name of the monitoring agent, an entity column 26 that identifies all available monitors and an enabled column 28 indicating if the monitoring agent is currently enabled.

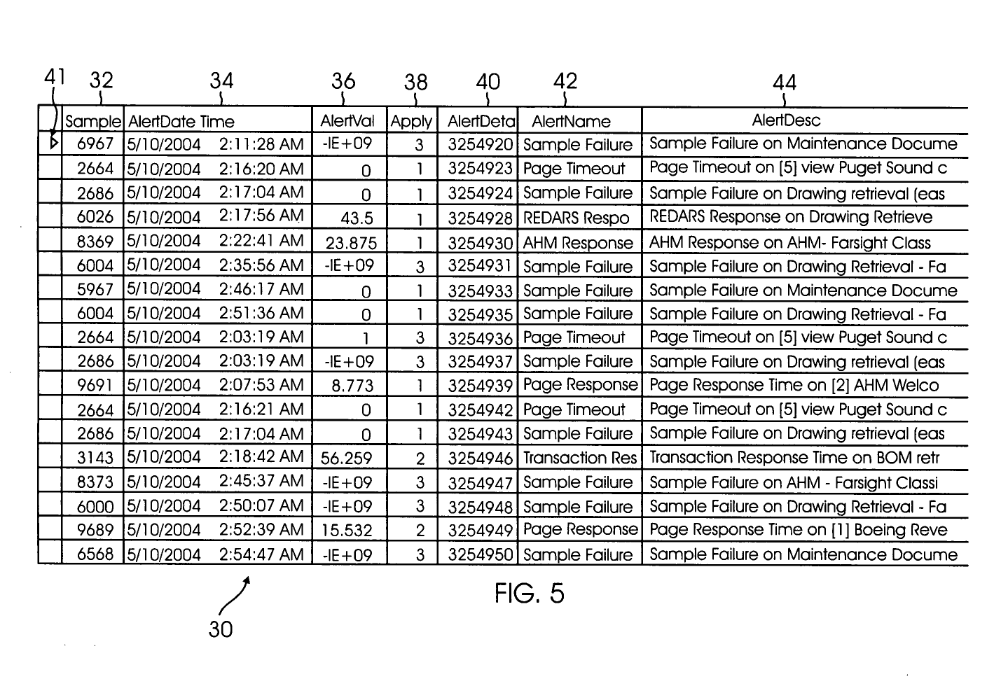

Any event that occurs in the system, such as the failure of a component on an aircraft, is recorded in an events log 30 illustrated in FIG. 5. Events log 30 records the data by indicating the sample ID 32 identifying the type of event, the date and time that the alert was sent 34, the value of the data collected by the monitoring agent 36, the status of the alert 38, alert details 40, alert name 42 and a description of the alert 44. For example, referring to row one 41 in FIG. 5, an event that has occurred is identified by a sample ID of 5967, an alert based on the event was sent on May 10, 2004 at 2:11:28 AM, the value of the data was −1E+09, the status of the alert is critical, a pointer 3254920 points to a location where additional information about the event is stored, the name of the alert is identified as well as a description of where the alert occurred. The status of an alert is identified by a numeric value. If the alert has a value of 1, the event is normal. A value of 2 indicates a warning and a value of 3 indicates the event is critical and should be addressed immediately.

From the data recorded in events log 30, a frequency of events' occurrence can be computed and used to estimate the probability distribution for the corresponding node. In other words, based on the observed data, a probability of the event reoccurring is computed. For example in a web service domain; it can usually be estimated if the Internet is slow or has traffic. After the graphical structure is built and the probability distributions are obtained, the modeling process for a Bayesian network is complete. Then using the available reasoning engine for the Bayesian network framework, intelligent reasoning based on the model can be performed.

The Bayesian network which is generated can display the columns of nodes in various colors to easily identify the type of node. For example, yellow could indicate hardware such as a computer, host or Internet. Red could indicate software, such as a web application or a server. Pink could indicate monitoring agents and green could indicate observations or messages.

Although the present invention has been described with reference to specific embodiments, these embodiments are illustrative only and not limiting. Many other applications and embodiments of the present invention will be apparent in light of this disclosure and the following claims.

What is claimed is:

1. A method of building a reasoning model using relational databases, comprising:
Identifying data objects in the relational databases;
Determining dependency relationships between the data objects;
Translating the data objects into nodes of a Bayesian network; and
Automatically translating the dependency relationships into a graphical structure of a Bayesian network.

2. The method of claim 1, wherein the data objects are identified relative to a reasoning task from multiple tables in the relational databases.

3. The method of claim 1 further comprising computing a frequency of events' occurrence to estimate probability distribution for nodes.

4. The method of claim 1 further comprising performing intelligent reasoning based on the network.

5. The method of claim 1 wherein the Bayesian network is comprised of five columns.

6. The method of claim 5, wherein the first column represents host computers.

7. The method of claim 5, wherein the second column represents web applications.

8. The method of claim 5, wherein the third column represents monitoring agents.

9. The method of claim 5, wherein the fourth and fifth columns represent observation nodes.

10. The method of claim 1 further comprising issuing an alert upon the occurrence of an event.

11. The method of claim 10, wherein alerts are classified as critical, warning or normal.

12. The method of claim 1 further comprising
monitoring data using monitoring agents; and
generating observations nodes based upon the monitored data.

13. The method of claim 1 further comprising computing posterior probability based on observations or partial observations.

14. The method of claim 1, wherein monitored data is stored in an events log.

15. A system of building a reasoning model using relational databases,comprising:
At least one server for storing data of a system having numerous interconnected parts;
Monitoring agents for monitoring the data of the numerous interconnected parts stored in the system;
An events log for storing any event observed by the monitoring agents; and
Relational databases for storing data objects, the data objects correspond to the data of the numerous interconnected parts.

16. The system of claim 15, wherein an event includes any type of occurrence in the system.

17. The system of claim 16, wherein an occurrence includes a failure of a system component or the delivery of information.

18. The system of claim 15, wherein the at least one server is a host computer.

19. The system of claim 15 wherein dependency relationships between the data objects are determined.

20. The system of claim 19, wherein the data objects are translated into nodes of a Bayesian network

21. The system of claim 20, wherein the dependency relationships are automatically translated into a graphical structure of a Bayesian network.
